(19) United States
(12) Patent Application Publication
(10) Pub. No.: US 2006/0267775 A1
(43) Pub. Date: Nov. 30, 2006

(54) Method of mounting radio tag chips and method of writing management information onto radio tag chips

(75) Inventor: Seigo Kodama, Yatomi-shi (JP)

Correspondence Address: FOLEY AND LARDNER LLP;SUITE 500, 3000 K STREET NW, WASHINGTON, DC, 20007, US

(73) Assignee: FUJI MACHINE MFG. CO., LTD.

(21) Appl. No.: 11/438,343

(22) Filed: May 23, 2006

(30) Foreign Application Priority Data
May 23, 2005 (JP) 2005-148865

(51) Int. Cl. G08B 13/14

(52) U.S. Cl. 340/572.8; 340/572.1

(57) ABSTRACT

A method of mounting a radio tag chip on an object to be managed, includes mixing a number of radio tag chips into a fluid, thereby making a tag-chip containing fluid, and applying the tag-chip containing fluid to the object so that at least one radio tag chip is contained in the applied tag-chip containing fluid, the applied tag-chip containing fluid being solidified or hardened, thereby mounting the radio tag chip on the object.

### BACKGROUND OF THE INVENTION

1. Field of the Invention

The present invention relates to a method of mounting a radio tag chip to an object to be managed and further to a method of writing management information onto the radio tag chip.

2. Description of the Related Art

In electronic component mounting systems, a radio tag chip storing management information has recently been mounted on an object to be managed for the purpose of managing information such as identification (ID) codes of circuit boards. Thus, the management information stored on the radio tag chip can externally be read by a reader/writer in a non-contact manner. JP-A-2004-87582 discloses one of the above-described methods. In this method, a work for mounting a radio tag chip on a circuit board as the object to be managed is carried out in the same manner as a work for mounting other electronic components. More specifically, a tape feeder accommodating radio tag chips is set on a chip mounter and thereafter, the chip mounter is driven so that radio tag chips supplied from the tape feeder are adsorbed one by one by an adsorption nozzle and mounted on and soldered to predetermined positions (portions to which a solder paste has in advance been applied) of a circuit board.

Sizes of the radio tag chips have recently been reduced with size reduction of other semiconductor chips. More recently developed microminiature radio tag chip has a chip size of 0.4 mm×0.4 mm and further size reduction is expected. It is difficult to mount the microminiature radio tag chips by a chip mounter. Moreover, an article on which a radio tag chip is mounted is limited to circuit boards. Thus, it would be impossible to mount radio tag chips on various shapes of articles such as various feeders, trays and the like.

Furthermore, manually mounting radio tag chips on the feeders, trays and the like is troublesome and accordingly, the manual work is not preferred. Accordingly, in current mounting lines for the electronic components, radio tag chips are not used for information management of the feeders, trays and the like other than circuit boards but bar code labels are adhered to electronic components, instead. Thus, the management of electronic components depends upon visual check by operators.

However, since an amount of information recordable on a bar code label is extremely smaller as compared with a radio tag chip, it is difficult to record, on a bar code label, various management information necessitated for automation of the manufacturing process. Moreover, it would be impossible to add new information to recorded information of bar code label later or to change the contents of the recorded information of bar code label later. Furthermore, objects to be managed sometimes lack marginal space to which a bar code label is to be adhered, depending upon the sizes or shapes of the objects. However, human errors are inevitable when the management of electronic components depends upon visual check by operators.

### SUMMARY OF THE INVENTION

Therefore, an object of the present invention is to mount a microminiature radio tag chip easily on the object to be managed, irrespective of the size and shape of the object.

In one aspect, the present invention provides a method of mounting a radio tag chip on an object to be managed, comprising mixing a number of radio tag chips into a fluid, thereby making a tag-chip containing fluid, and applying the tag-chip containing fluid to the object so that at least one radio tag chip is contained in the applied tag-chip containing fluid, the applied tag-chip containing fluid being solidified or hardened, thereby mounting the radio tag chip on the object.

In the above-described method, when microminiature tag chips are used, a number of radio tag chips can be diffused in the fluid substantially uniformly. Accordingly, for example, the chip containing fluid can easily adhere to the objects with various sizes and shapes by way of application or printing using applying means such as a dispenser or printing means. Consequently, the radio tag chip can easily be mounted on the object irrespective of the size or shape of the object.

In a preferred form, the fluid is a printing ink or an adhesive. Consequently, the radio tag chips can reliably be fixed on the object using a commercially available inexpensive fluid.

The above-described tag chip mounting method is applicable to information management systems for various articles and apparatus. For example, the invention may be applied to a step of mounting the radio tag chip on at least one of a component feeder set on an electronic component mounter, a tray set on the component feeder, a reel set on the component feeder, a cartridge set on the component feeder, an electronic component supplied from the component feeder, and a circuit board. Consequently, an information management system in an electronic component mounting line can be constructed using the radio tag chips.

Furthermore, management information about the object is transmitted, by radio, to a rewritable non-volatile memory incorporated in the radio tag chip mounted on the object by a data writer thereby to be written onto the memory. Consequently, the radio tag chip is mounted on the object and thereafter, information can be added to the information stored on the radio tag chip at any time and/or the information stored on the radio tag chip can be changed at any time.

### BRIEF DESCRIPTION OF THE DRAWINGS

Other objects, features and advantages of the present invention will become clear upon reviewing the following description of the embodiment, with reference to the accompanying drawings, in which:

FIG. 1 is a block diagram of arrangement of radio tag chip in one embodiment of the present invention;

FIG. 2 is a view schematically showing a number of microminiature radio tag chips mixed into a fluid and diffused

FIG. 3 is a perspective view of a dispenser for applying a tag-chip containing fluid; and

FIG. 4 illustrates a tray to which the tag-chip containing fluid is applied.

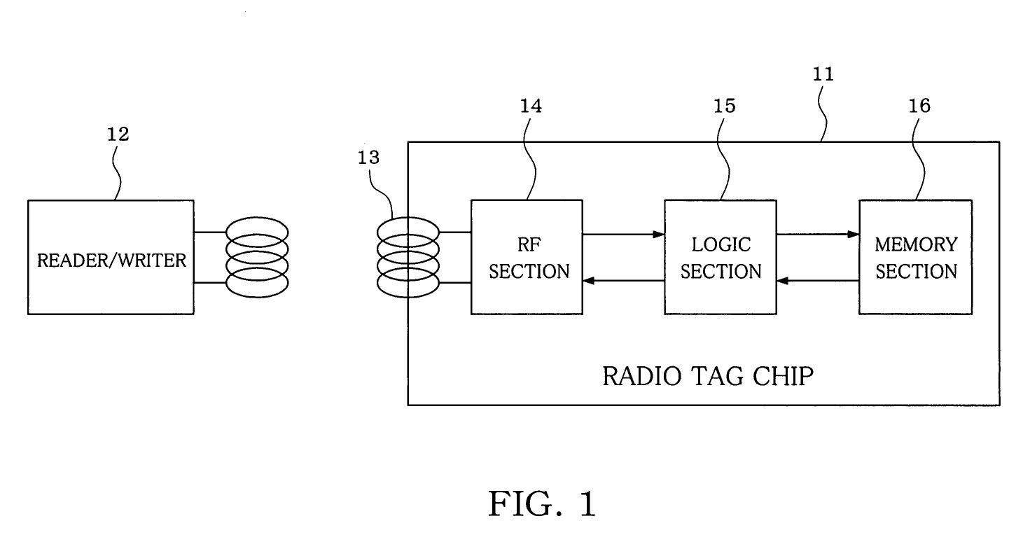

### DETAILED DESCRIPTION OF THE INVENTION

One embodiment of the present invention will be described with reference to the accompanying drawings. The invention is applied to management of component information for a tray of a tray feeder in an electronic component mounter.

A radio tag chip 11 used in the embodiment is a microminiature radio tag chip having a chip size of 0.4 mm×0.4 mm, for example. The radio tag chip 11 incorporates an antenna coil 13 receiving radio signals from a reader/writer 12. The radio tag chip 11 further includes a radio frequency (RF) section 14, a logic section 15 and a memory 16. The RF section 14 converts AC power transmitted from the reader/writer 12 into DC power, which serves as power supply operating various circuits.

The RF section 14 transmits and receives radio signals to and from the reader/writer 12 through the antenna coil 13. The logic section 15 processes the radio signals received by the antenna coil 13 and accesses to the memory 16 for the writing and reading of data to and from the memory 16, thereby originating transmission data. The memory section 16 is comprised of a rewritable non-volatile memory such as ferroelectric random access memory (FRAM) or electronically erasable and programmable read only memory (EEPROM).

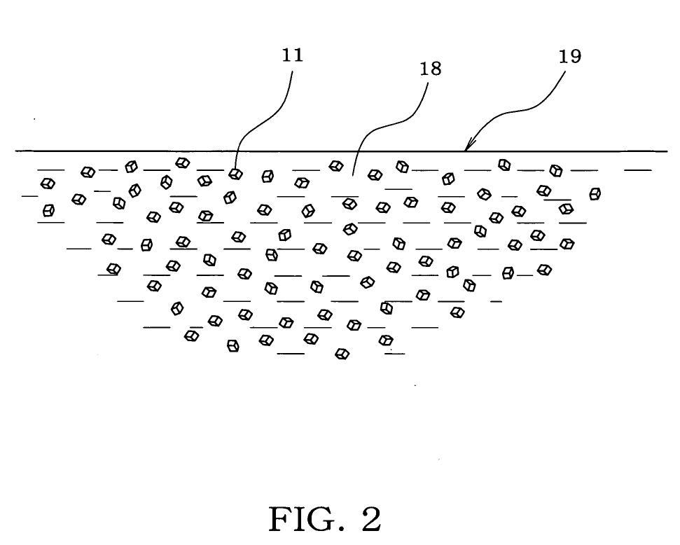

When the radio tag chip 11 is to be applied to a tray 17 serving as an object to be managed, a number of microminiature radio tag chips 11 are mixed into the fluid 18 firstly and diffused substantially uniformly into the fluid 18 so that a tag-chip containing fluid 19 is made, as shown in FIG. 2. It is desirable that the fluid 18 have such a viscosity as to maintain the radio tag chips 11 substantially in a uniformly diffused state and have a function of securing the radio tag chip 11 to the tray 17. For example, the fluid 18 may be a printing ink or adhesive agent. The painting ink or adhesive agent may be of an ultraviolet cure type, thermosetting type, thermoplastic type, acqueous-based type, solvent type or the like. It is preferable that the painting ink or adhesive agent should have non-conductivity in a solidified or hardened state so as not to shield electric waves of radio communication.

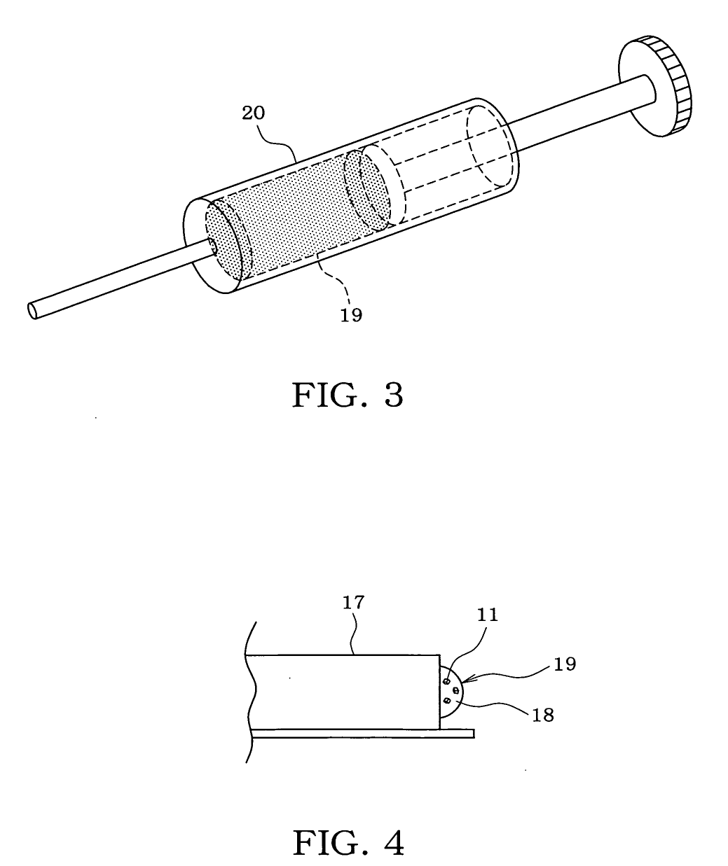

The tag-chip containing fluid 19 is accommodated, for example, in applying means such as a dispenser 20 (see FIG. 3), printing means, marking pen or the like. A small amount of tag-chip containing fluid 19 is applied to a blank space of the tray 17 serving as an object to be managed so that at least one of the radio tag chips 11 is contained in the applied tag-chip containing fluid 19, as shown in FIG. 4. This work may be manually performed or automated. Subsequently, the tag-chip containing fluid 19 applied to the tray 17 is solidified or hardened in a manner (ultraviolet cure, thermosetting, air drying, drying by heating, etc., for example) according to a type of the fluid 18. As a result, at least one radio tag chip 11 is secured on an blank space of the tray 17.

Subsequently, the tray 17 or reader/writer 12 (data writing device) is moved to a distance or position where radio communication is possible between reader/writer 12 and the radio tag chip 11 of the tray 17. Data of management information such as component identification (ID) or the like of the tray 17 is transmitted from the reader/writer 12 thereby to be written onto the memory section 16 of radio tag chip 11. Subsequently, when the tray type feeder accommodating the tray 17 is set on an electronic component mounter, the management information of the tray 17 stored on the radio tag chip 11 is read by the reader/writer provided in the electronic component mounter. As a result, a control device of the electronic component mounter obtains the management information of the tray 17, checking the component ID of the tray 17 and the like and writing new information onto the memory 16 of the radio tag chip 11 in case of necessity.

According to the foregoing embodiment, the microminiature radio tag chip 11 is used and accordingly, a number of radio tag chips 11 can be diffused into the fluid 18 substantially uniformly. Consequently, the tag-chip containing fluid 19 can easily be applied to the objects (tray 17) with various sizes and shapes by application or printing using, for example, applying means such as the dispenser 20 or printing means and accordingly, the radio tag chip 11 can easily be mounted on the object to be managed (tray 17) irrespective of the size and shape of the object.

Although the radio tag chip 11 is mounted on the tray 17 in the foregoing embodiment, the radio tag chip 11 may be mounted on any one of a component feeder such as a tray type feeder, tape feeder, a bulk feeder and the like, a component cassette such as a reel, cartridge and the like set on the component feeder, electronic components supplied from the component feeder and a circuit board in the same manner as in the foregoing embodiment, thereby managing the information.

Thus, the present invention should not be limited to the field of electronic component mounting technique but may be applied to information management systems of various articles and apparatus in other technical fields.

The foregoing description and drawings are merely illustrative of the principles of the present invention and are not construed in a limiting sense. Various changes and modifications will become apparent to those of ordinary skill in the art. All such changes and modifications are seen to fall within the scope of the invention as defined by the appended claims.

What is claimed is:

1. A method of mounting a radio tag chip on an object to be managed, comprising:
mixing a number of radio tag chips into a fluid, thereby making a tag-chip containing fluid; and
applying the tag-chip containing fluid to the object so that at least one radio tag chip is contained in the applied tag-chip containing fluid, the applied tag-chip containing fluid being solidified or hardened, thereby mounting the radio tag chip on the object.

2. The method according to claim 1, wherein the fluid is a printing ink or an adhesive.

3. The method according to claim 1, wherein the object is at least one of a component feeder set on an electronic component mounter, a tray set on the component feeder, a reel set on the component feeder, a cartridge set on the component feeder, an electronic component supplied from the component feeder, and a circuit board.

4. A method of writing management information about an object to be managed onto a radio tag chip, comprising:
mixing a number of radio tag chips into a fluid, thereby making a tag-chip containing fluid;
applying the tag-chip containing fluid to the object so that at least one radio tag chip is contained in the applied tag-chip containing fluid, the applied tag-chip containing fluid being solidified or hardened, thereby mounting the radio tag chip on the object; and
transmitting, by radio, the management information about the object to a rewritable non-volatile memory incorporated in the radio tag chip mounted on the object by a data writer, thereby writing the management information data onto the memory.
